(19) United States
(12) Patent Application Publication
(10) Pub. No.: US 2026/0169516 A1
(43) Pub. Date: Jun. 18, 2026

(54) PERIPHERAL DEVICE FOR MRI SYSTEM

(71) Applicant: Siemens Healthineers AG, Forchheim (DE)

(72) Inventors: Jan Bollenbeck, Eggolsheim (DE); JianMin Wang, ShenZhen (CN); Qian Yun Pang, ShenZhen (CN)

(21) Appl. No.: 18/887,492

(22) Filed: Sep. 17, 2024

(30) Foreign Application Priority Data
Sep. 18, 2023 (CN) 202311204764.8

(51) Int. Cl. G06F 1/08

(52) U.S. Cl. CPC G06F 1/08

(57) ABSTRACT

A peripheral device for an MRI system. The peripheral device includes a sensor for receiving a control signal in a surrounding environment of the peripheral device. The peripheral device is configured to obtain, from the control signal, control information of the peripheral device and a reference clock signal for signal processing in the peripheral device. The control information is modulated to the control signal by phase modulation.

### CROSS REFERENCE TO RELATED APPLICATIONS

This application claims the benefit of CN 202311204764.8 filed on Sep. 18, 2023, which is hereby incorporated by reference in its entirety.

### FIELD

Embodiments relate to a peripheral device for an MRI system.

### BACKGROUND

A magnetic resonance imaging (MRI) system is an imaging apparatus which uses a strong external magnetic field to align the nuclear spins in an examination subject, and excites the nuclear spins by an alternating magnetic field to precess around this alignment, in order to perform imaging of the examination subject. The precession or return of the spins from this excited state to a lower-energy state then generates an alternating magnetic field in response, and this alternating magnetic field is received via an antenna.

Position encoding is applied to signals by gradient magnetic fields, and this position encoding then enables the received signals to correspond to volume elements. The received signals are then evaluated, and 3D imaging display of the examination subject is provided. Local receiving antennas, i.e. so-called local coils, may be used to receive the signals, and in order to achieve a better signal-to-noise ratio, these local coils are arranged on the examination subject directly.

These local coils are usually connected to the MRI system via cables; through these cables, received signals are transmitted to perform image reconstruction, and energy and control signals are supplied to the local coils.

MRI for image generation similarly relies on precise phase information, so the local coils need to have a precise and unified phase reference.

However, other wireless peripheral devices for MRI systems may likewise be used, and clock and control information of stable phase and frequency must be supplied to these wireless peripheral devices; the sole purpose of this is to reduce interference caused to image acquisition by the peripheral devices. These may for example be sensors for detecting physiological values of a patient, or operating or communication devices.

Publication DE 10 2021 206 483 A1 has disclosed a local coil and an MRI system, wherein the MRI system transmits a reference clock to the local coil optically, wherein control information is transmitted between two modulation frequencies with the aid of keying. The modulation frequencies are modulated to an optical signal by amplitude modulation.

### BRIEF SUMMARY AND DESCRIPTION

The scope of the present disclosure is defined solely by the claims and is not affected to any degree by the statements within this summary. The present embodiments may obviate one or more of the drawbacks or limitations in the related art. Independent of the grammatical term usage, individuals with male, female or other gender identities are included within the term.

Embodiments provide a better peripheral device with a lower cost, in particular a wireless local coil.

In an embodiment of a peripheral device, the peripheral device includes a sensor for receiving an electrical and/or magnetic control signal in a surrounding environment of the peripheral device, wherein the peripheral device is configured to obtain, from the control signal, control information of the peripheral device and a reference clock (signal) for signal processing in the peripheral device, and the control information is modulated to the control signal by phase modulation. In other words, the peripheral device is configured to obtain control information from the control signal by a phase modulator.

Advantageously, a frequency of the peripheral device may be stabilized by the reference clock, thereby reducing interference. Phase modulation can reliably transmit control information without reference clock interference; this is expounded below.

In an embodiment of the peripheral device, the peripheral device is configured to obtain the phase modulation with phase shift keying at 360/n degrees to obtain the control information, wherein the natural number is greater than 1.

Advantageously, the density of information transmitted may be increased by phase shift keying having multiple steps.

In an embodiment of the peripheral device, the peripheral device includes a frequency multiplier with a coefficient of n, wherein the reference clock is obtained by frequency multiplication.

Advantageously, due to frequency multiplication with a coefficient of n, a modulated phase jump of 360 degrees/n becomes a phase jump of 360 degrees at the multiplied frequency, so the frequency has phase stability as a reference.

In an embodiment of the peripheral device, the value n of frequency multiplication and the divisor during phase modulation is equal to 2. In other words, phase modulation is implemented by a 180 phase jump, and a reference frequency is equivalent to double the frequency of the control signal.

In an embodiment, the peripheral device is a local coil of an MRI system. The local coil includes an antenna coil for receiving a magnetic resonance signal for implementing image acquisition with the MRI system. Image acquisition without interference requires a clearly defined frequency and phase relationship, which is ensured by the reference clock. The reference clock is used to process a magnetic resonance signal for image acquisition, so as to perform frequency conversion for example, and/or is used as a digitized clock.

The peripheral device is configured for use with an MRI system. During image acquisition, the peripheral device causes no interference, or causes as little interference as possible. The peripheral device may be wireless, i.e. does not employ a wired connection to the MRI system, but a wired implementation solution may likewise be used. Hereinbelow, referring to an embodiment, the peripheral device is a local coil.

The peripheral device includes a sensor for receiving an electric control signal, a magnetic control signal or an electromagnetic control signal in a surrounding environment of the peripheral device. The control signal is transmitted by an electric alternating field, a magnetic alternating field or an electromagnetic alternating field. The frequency of the alternating field may be greater than 1 MHz, 10 MHz, 100 MHz or 1 GHz. Reception may be implemented by capacitance, inductance or by free field transmission. Signals may also be optical signals. The sensor may for example be an electric antenna, a magnetic antenna, an inductive coil or a photoelectric detector. A space provided with an MRI system, for example a patient tunnel of an MRI system, is regarded as the surrounding environment.

The peripheral device is configured to obtain, from the control signal, control information of the peripheral device and a reference clock for signal processing in the peripheral device. A periodic signal is called a reference clock; this signal defines a frequency, and a stable time reference for the reference clock can be realized by phase. A solution in which a reference clock may be obtained from a control signal for example is described below with reference to the dependent claims and the drawings.

All information of the MRI system that may be used to control the peripheral device to change operating state is regarded as control information. The operating state may for example be a stationary state of an operating device, or a so-called detuned state of a local coil. Similarly, amplification may be set or an input channel may be selected.

The abovementioned objective is also achieved by a system, the system having an MRI system and the peripheral device. The MRI system includes a reference clock generator, a modulator and a control signal sender. The reference clock generator is configured to supply a reference clock of stable phase and frequency. The reference clock may be derived from a central clock of the MRI system; the central clock similarly presets a clock for detecting and analyzing magnetic resonance data. The MRI system also includes a modulator. The modulator is in signal connection with the reference clock generator, and obtains the reference clock from the reference clock generator. The modulator is configured to modulate the reference clock with control information by phase modulation. Control information is preferably supplied by a controller of the MRI system, and is related to sequence execution. The MRI system also includes a control signal sender for wireless transmission of a control signal. The control signal sender is in signal connection with the modulator, and thereby receives the reference clock modulated with the control signal, and transmits the control signal into the surrounding environment of the peripheral device in the MRI system. This may for example be implemented by an antenna, an inductive coil or an optical transmitter, such as an LED or laser.

Advantageously, the system is able to control an operation in the peripheral device within a sequence for the MRI system, thereby providing reliable and optimized image acquisition.

In an embodiment of the system, the modulator is configured to implement phase modulation in a zero-crossing point of the reference clock. For example, in phase modulation with a phase switch of 180 degrees, the switch is implemented at the zero-crossing point, the specific method being to switch the polarity of the output signal at the zero-crossing point, i.e. the output signal of the modulator is reversed until the next modulation step.

### BRIEF DESCRIPTION OF THE DRAWINGS

FIG. 1 depicts a schematic drawing of a system, formed by an MRI system and an electronic peripheral device according to an embodiment.

FIG. 2 depicts a block diagram of a transmission system for transmitting a clock signal and a control signal according to an embodiment.

FIG. 3 depicts a schematic drawing of an illustrative embodiment of the modulator of the system.

FIG. 4 depicts a schematic drawing of an illustrative embodiment of the demodulator of the system.

### DETAILED DESCRIPTION

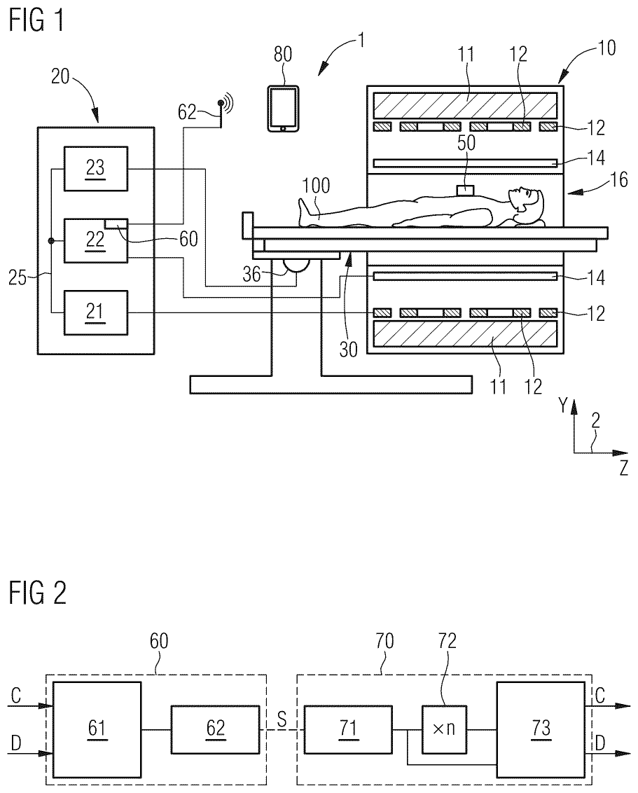

FIG. 1 depicts a schematic drawing of an embodiment of a system, formed by an MRI system 1 and an electronic peripheral device.

A magnet unit 10 includes a field magnet 11, which generates a static magnetic field B0 for aligning nuclear spins of a sample or a patient 100 in a recording region. A characteristic of the recording region is an extremely uniform static magnetic field B0; uniformity therein is in particular related to the strength or absolute value of the magnetic field. The recording region is approximately spherical and arranged in a patient tunnel 16, which extends through the magnet unit 10 in a longitudinal direction 2. A patient examination table 30 is moved in the patient tunnel 16 by a moving unit 36. The field magnet 11 is generally a superconducting magnet capable of providing a magnetic field with a magnetic flux density of as high as 3 T, and in the latest devices, is even able to provide a magnetic field of higher magnetic flux density. However, lower magnetic field strengths may also be achieved using permanent magnets or electromagnets with normally conducting coils.

In addition, the magnet unit 10 includes gradient coils 12, which are configured to superimpose time- and space-varying magnetic fields in three spatial directions onto the magnetic field B0, in order to perform spatial differentiation of an imaging region acquired in a volume under examination. The gradient coils 12 generally have coils made of normally conducting wire, and these coils are able to generate mutually orthogonal fields in the volume under examination.

The magnet unit 10 also includes a body coil 14, which is configured to radiate high-frequency signals, provided via signal lines, to the volume under examination, and receive magnetic resonance signals emitted by the patient 100 and output same via the signal lines.

Different signals for the gradient coils 12 and the body coil 14 are supplied to the magnet unit 10 by a control unit 20, which also evaluates received signals.

Thus, the control unit 20 includes a gradient controller 21, which is configured to supply variable currents to the gradient coils 12 via feed lines; these currents provide the desired gradient fields in the volume under examination in a time-coordinated manner.

The control unit 20 also includes a high-frequency unit 22, which is configured to generate high-frequency pulses having a predetermined time curve, amplitude and spectral power distribution, so as to excite magnetic resonance of the nuclear spins of the patient 100. Pulse frequencies in the range of kilowatts may be achieved. Excitation signals may be radiated to the patient 100 via the body coil 14 or a local transmitting antenna.

A controller 23 communicates with the gradient controller 21 and the high-frequency unit 22 via a signal bus 25.

There are many peripheral devices or ancillary devices in the environment of the MRI system 1, and these devices may participate in the detection of magnetic resonance images. These devices may be operating elements, apparatuses for communicating or conversing with the patient, or physiological sensors for detecting physiological parameters of the patient 100. Examples of peripheral devices in the present invention are a local coil 50 or a tablet computer 80.

Many of these peripheral devices contain digital circuits or processors, whose clock signals and derived signals might cause interference. When signal processing is performed, frequency components lower than the clock frequency are in particular generated; the frequency thereof is generally an integer fraction of the clock frequency, and will generate harmonics. However, if the clock frequency is chosen appropriately, it can be ensured that these interference signals are between valid frequencies of a processing path for magnetic resonance signals or downstream signals, and will not cause interference. However, the clock frequency must be stable enough to not migrate to an interference frequency range due to temperature change, for example. Thus, the MRI system 1 includes a transmission apparatus for wireless transmission of clock signals, such as a control signal sender 60. A clock signal is preferably derived from a stable main clock of the MRI system 1, and the control unit 20 supplies this main clock to the control signal sender 60. When optical transmission is performed, the clock signal may be modulated to an optical carrier. When transmission is performed by an electrical and/or magnetic alternating field in the RF range, the clock signal may be transmitted by the frequency of the alternating field directly.

The peripheral devices also need control signals. The control signals may involve simple connecting and disconnecting or enabling/disabling functions, so as to prevent the peripheral devices from interfering with image acquisition, for example. The control signals may also enable a protection function, such as detuning of the local coil 50, to prevent the local coil 50 from being damaged, or the patient 100 from sustaining harm related to excitation pulses.

FIG. 2 depicts a schematic block diagram of a transmission path for a clock and control signal. The transmission path includes the control signal sender 60 containing a modulator 61. The control unit 20 conveys the clock signal and control information to the modulator 61. The control information is modulated to the clock signal in the modulator 61. Details and different embodiments are explained with reference to the drawings. An emitter 62 then emits a modulated control signal, so as to transmit same.

In wired transmission, the emitter 62 may for example be a power driver or a small power amplifier adjusted according to the transmission line. In wireless transmission by an electric field, a magnetic field or an electromagnetic field, the emitter 62 may for example be an electric antenna or a magnetic induction coil, which may likewise have an amplifier. In optical transmission, an LED or a laser may be used as the emitter 62.

A complementary sensor 71 for receiving the control signal is provided at the peripheral device side. It may similarly be an antenna or an induction coil, or an optical receiver, such as a phototube or photodiode. The sensor 71 may likewise have an amplifying element for amplifying the received control signal, so as to adjust this control signal to a predetermined level.

The received control signal is then conveyed to a demodulator 63, which extracts the clock signal and control information by demodulation. The control signal with its frequency multiplied by an integer coefficient n is likewise conveyed to the demodulator 73 by a frequency multiplier 72. For example, frequency multiplication may be achieved by bidirectional rectification of the control signal. For example, odd multiples may be achieved by conversion to a square wave signal or by subsequent removal of desired harmonics by filtering. For example, other multiplication coefficients may also be achieved using a PLL circuit.

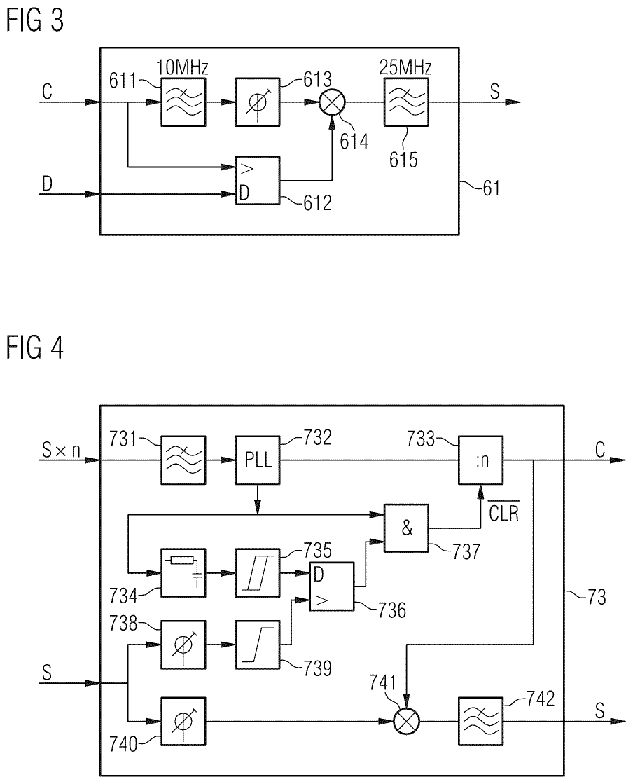

FIG. 3 depicts an illustrative embodiment of the modulator 61 of the system. A clock signal C and control information D to be modulated are conveyed to the modulator 61.

Most clock signals C are square wave signals; for this reason, a first low-pass filter 611 is used for filtering first, to produce an approximately sinusoidal signal, which includes relatively few interference harmonics. A phase shifter 613 is then used to implement adjustable phase shift; the function of the phase shifter will be explained below.

The control information D or data signal is synchronized with an edge of the clock signal C by a trigger 612, and then multiplied, as a bipolar signal, by the low-pass filtered clock signal in an analog multiplier 614 or frequency mixer. The product is low-pass filtered, and supplied as a BPSK modulated control signal for transmission.

To keep the interference caused by the conversion process at an extremely low level, the phase conversion time is set in a zero-crossing point of the clock signal by the phase shifter 613, which may be set in a static state. The limit frequency of a downstream output low-pass filter 615 is more than double the signal frequency, to make the conversion process as successful as possible. In an example, a 25 MHz 7th-order Chebyshev low-pass filter is used as the output low-pass filter 615 in a 10 MHz clock frequency.

FIG. 4 depicts schematically an illustrative embodiment of the demodulator 73. The control signal, and the control signal with its frequency multiplied by the coefficient n, are conveyed to the demodulator 73; these control signals are for example outputted by the sensor 71 and supplied by the frequency multiplier 72. In the simplest scenario, the coefficient n is equal to 2.

A bandpass filter 731 filters the frequency-multiplied control signal, and conveys it as a reference frequency to a simple PLL 732. The PLL 732 operates as a jitter cleaner at a small loop bandwidth (e.g. 50 Hz). The PLL 732 eliminates the interference action of data modulation, and noise that arises due to dynamic insufficiency of amplitude of the transmission channel. Apart from the loop bandwidth, signal quality is mainly determined by the quality of the VCXO inside the PLL. Then after frequency division by n in a frequency divider 733, a clock signal C is provided at an output end. There is no longer any modulation on this signal.

BPSK demodulation of the control information D is implemented by simple multiplication of a modulated control signal S and the clean output clock signal C in a multiplier 741. The mixed product is filtered in a low-pass filter 742, using a 5th-order Butterworth low-pass filter for example, and then outputted as a data signal D.

The combination of a Schmitt trigger 735 and an RC low-pass filter 734 ensures that further processing of a “locked detection” signal of the PLL 732 is performed only when the PLL 732 is already reliably locked. A trigger 736 timed with the received signal S generates, from an output signal of the Schmitt trigger 735, a switch signal synchronized with the clock signal. This switch signal is logically linked to the unfiltered “locked detection” signal via an AND operation in an AND gate 737. It is thus ensured that when the received signal is interrupted, the output signal or clock signal C is cut off immediately. The output signal C is issued in synchrony with a 10 MHz received signal only if a PFD includes a stable “locked detection” signal. A signal edge of a clock input end of the trigger 736 is set by a static phase shifter 738 and a threshold switch 739 in cooperation with a CLEAR function of the frequency divider 733. The triggered CLEAR function ensures that the data signal, after connection, includes a defined logic state. A signal phase of maximum detector sensitivity is set by a static phase shifter 740. The control signal or data signal D may then either be used as a switch signal directly, or first be decoded as a serial data signal, so as to control multiple control functions.

Although the embodiment with the additional functions (such as synchronization of data and clock signals or stabilization of amplitude and jitter of the clock signal) shown in FIG. 4 is beneficial for operation, transmission of the clock signal and control information and the modulated control signal according to the present invention can also be achieved without these additional functions.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that the dependent claims may, alternatively, be made to depend in the alternative from any preceding or following claim, whether independent or dependent, and that such new combinations are to be understood as forming a part of the present specification.

While the present disclosure has been described above by reference to various embodiments, it may be understood that many changes and modifications may be made to the described embodiments. It is therefore intended that the foregoing description be regarded as illustrative rather than limiting, and that it be understood that all equivalents and/or combinations of embodiments are intended to be included in this description.

1. A peripheral device for an MRI system, the peripheral device comprising:
a sensor configured to receive an electrical control signal and/or a magnetic control signal in a surrounding environment of the peripheral device, wherein the peripheral device is configured to obtain, from the electrical control signal and/or the magnetic control signal, control information of the peripheral device, wherein a reference clock signal is used for signal processing in the peripheral device, wherein the control information is modulated to the electrical control signal and/or the magnetic control signal by phase modulation.

2. The peripheral device of claim 1, wherein the peripheral device is configured to demodulate the phase modulation with phase shift keying at 360/x degrees to obtain the control information, wherein x is a natural number greater than 1.

3. The peripheral device of claim 2, wherein the peripheral device includes a frequency multiplier for multiplying a frequency of the electrical control signal and/or the magnetic control signal by a coefficient n, wherein the peripheral device is configured to obtain the reference clock signal by frequency multiplication of the electrical control signal and/or the magnetic control signal.

4. The peripheral device of claim 3, wherein the coefficient n is equal to 2.

5. The peripheral device of claim 1, wherein the peripheral device is a local coil of the MRI system, the local coil configured to use the reference clock signal to process a magnetic resonance signal for image acquisition.

6. A system comprising:
a peripheral device comprising a sensor configured to receive an electrical control signal and/or a magnetic control signal in a surrounding environment of the peripheral device, wherein the peripheral device is configured to obtain, from the electrical control signal and/or the magnetic control signal, control information of the peripheral device, wherein a reference clock signal is used for signal processing in the peripheral device, wherein the control information is modulated to the electrical control signal and/or the magnetic control signal by phase modulation; and
an MRI system, wherein the MRI system comprises a reference clock generator, a modulator, and a control signal sender, wherein the reference clock generator is configured to supply the reference clock signal to the modulator, the modulator is configured to modulate the reference clock signal with control information by phase modulation, and the control signal sender is configured to transmit the electrical control signal and/or the magnetic control signal into a surrounding environment of the peripheral device.

7. The system of claim 6, wherein the peripheral device is a local coil of the MRI system, the local coil configured to use the reference clock signal to process a magnetic resonance signal for image acquisition, wherein the modulator is configured to implement the phase modulation in a zero-crossing point of the reference clock signal.
